(19) United States
(12) Patent Application Publication
(10) Pub. No.: US 2017/0337757 A1
(43) Pub. Date: Nov. 23, 2017

(54) COMPUTER-IMPLEMENTED ELECTRONIC SURVEILLANCE SYSTEM AND METHOD

(71) Applicant: Kannakatti Bullappa, Sunnyvale, CA (US)

(72) Inventor: Kannakatti Bullappa, Sunnyvale, CA (US)

(21) Appl. No.: 15/157,874

(22) Filed: May 18, 2016

(51) Int. Cl. G07C 9/00; G06Q 20/32; G06Q 10/02; H04W 4/00; H04B 5/00

(52) U.S. Cl. CPC G07C 9/00166; H04W 4/008; H04B 5/0031; G06Q 10/02; G06Q 20/3278; G07C 9/00103

(57) ABSTRACT

Disclosed is a computer-implemented electronic surveillance system for allowing a user into a restricted area based on a virtual badge, which is representative of the user. The system comprises a user database listed with a plurality of user details, a badge generation module for generating a virtual badge based on the user details, the generated virtual badge residing within a smart device, an access database comprising a plurality of badge entries listed there within wherein, each badge entry comprising badge information representative of a virtual badge, the user of which has been pre-granted the right to access the restricted area, and an access means associated with the point of access of the restricted area, the access means comprising for upon the smart device being brought proximal thereto, receiving badge information and allowing the user to access the restricted area in the event of a match.

### BACKGROUND

The present disclosure relates to a computer-implemented electronic surveillance system and method and more particularly, to an electronic surveillance system and method that employs a virtual badge.

Traditionally, an identification card or a badge is a physical item, which is generally carried along with oneself and, even more commonly, worn by one over one's neck by means of a lanyard coupled thereto. Today, the badge has evolved from just an identification means to an access device for accessing a restricted area, such as, an office building, plant premises, etc. More particularly, the point of access (i.e., a door or a gate) of a restricted area is coupled with a reader or a scanner, which is configured to read the card before enabling the user thereof to access the restricted area in the event of the card being pre-granted the access.

Today, with the global proliferation and ubiquity of smart devices such as, smartphones, tablets, and the like, which, among other things, are built to hold different forms of information there within, the concept of holding onto the traditional physical badges would obviously be archaic. There is a need in the art to find a replacement for the physical badge with a virtual one and along with this, there's also a need for a computer-implemented system that supports said virtual badges.

### SUMMARY

An embodiment of the present invention comprises a computer-implemented electronic surveillance system for permitting a user's entrance into a restricted area based on a virtual badge wherein, the virtual badge is representative of the user. The virtual badge resides within the user's smart device such as a smartphone, tablet, or the like.

The system comprises a user database and a badge generation module, both of which are accessible by the user via a user interface of the smart device. The user database is listed with a plurality of user details, which include the details such as identity details, professional details and contact details of the user. Once the user details are inputted, the badge generation module is configured to generate a virtual badge for the user.

The system further comprises a virtual badge reader, which is disposed in operative communication with a point of access of the restricted area. The virtual badge reader comprises an access database, which comprises a plurality of badge entries listed therewithin. The badge entries comprise badge information pertaining to various virtual badges, the users of which have been pre-granted access into the restricted area. The virtual badge reader further comprises an interactive means for receiving badge information from a virtual badge upon the corresponding smart device being brought proximal thereto.

Upon the reception of the badge information from the smart device, a comparison module parses the access database and compares the received badge information against the badge entries. Upon match, the point of access is rendered accessible to the user.

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the accompanying drawings, which form a part of this disclosure, wherein:

FIG. 1, according to an embodiment of the present disclosure, is a partial block diagram of the computer-implemented electronic surveillance system.

FIG. 2, according to an embodiment of the present disclosure, is another partial block diagram of the computer-implemented electronic surveillance system.

FIG. 3, according to an embodiment of the present disclosure, is a flowchart depicting the computer-implemented electronic surveillance system.

The various aspects of the present disclosure mentioned above are described in further detail with reference to the aforementioned figures and the following detailed description of exemplary embodiments.

### FIGURES—REFERENCE NUMERALS

10—User Database
12—Badge Generation Module
14—User Interface
16—Smart Device
18—Wireless Communications Network
20—Virtual Badge Reader
22—Access Database
24—Comparison Module
26—Lock/Unlock Module

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

An embodiment of the present invention comprises a computer-implemented electronic surveillance system for permitting a user's entrance into a restricted area based on a virtual badge wherein, the virtual badge is representative of the user. The virtual badge is, as the name suggests, resides within the user's smart device such as a smartphone, tablet, or the like.

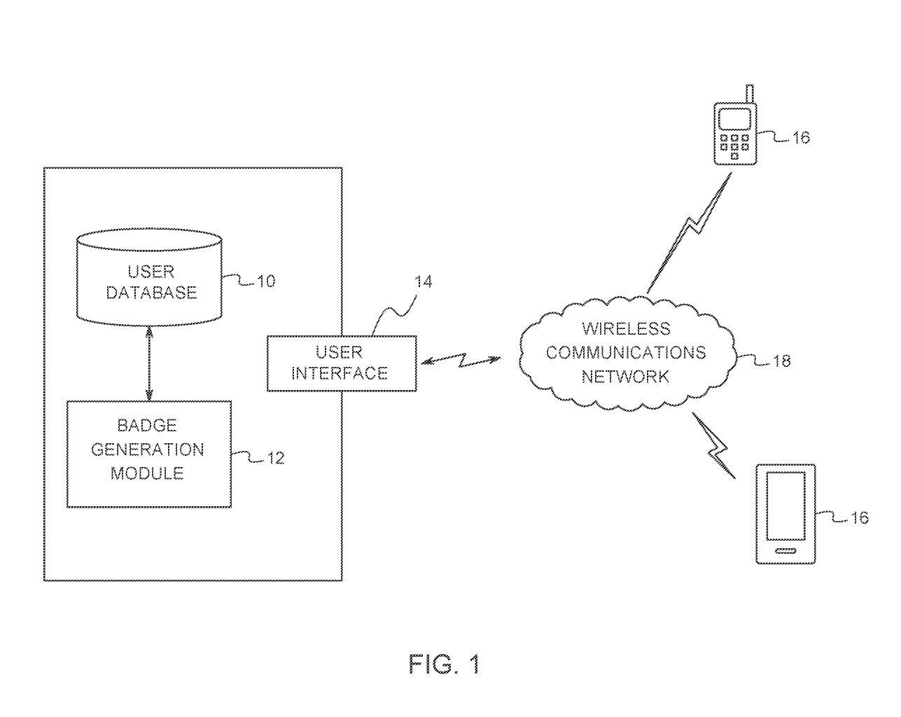

Referring to FIG. 1, the system comprises a user database 10 and a badge generation module 12, both of which are accessible by the user via a user interface 14 of the smart device 16 over a wireless communications network 18, such as the Internet. More particularly, the user interface 14 pertains to that of a dedicated computer application (or simply an app), which may be offered for download on a online market place such as, a Google Play Store, iPhone's App Store, or the like. The user database 10 is listed with a plurality of user details, which include the identity details, professional details, and the contact details of the user. The identity details of the user comprise the name, a photo image of the user, etc. The professional details of the user comprise the company which employed the user, the department of the user, the designation of the user, etc. The contact details of the user include the one or more phone numbers of the user, one or more email addresses of the user, one or more postal addresses of the user, etc. The user inputs his/her user details into user database 10 via the user interface 14 on his/her smart device 16. Once the user's user details are inputted, the badge generation module 12, which is disposed in operative communication with the user database 10, generates a virtual badge, which is representative of the user. The virtual badge may comprise an image file, a QR code, or even a barcode.

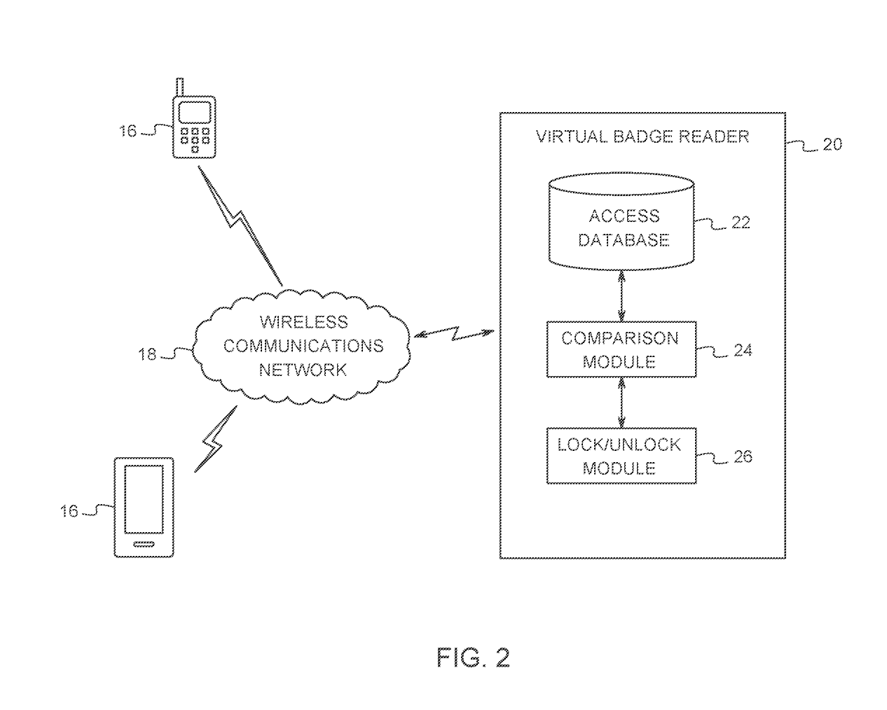

Referring to FIG. 2, the system further comprises a virtual badge reader 20, which is disposed in operative communication with a point of access of the restricted area. The restricted area may comprise an office, a rental premises, a hotel room, etc. The point of access comprises a door or a gate, the locking mechanism of which is controlled by the virtual badge reader 20. The virtual badge reader 20 comprises an access database 22, a comparison module 24, and a lock/unlock module 26, the utility of each of which will become apparent from the following body of text. The access database 22 comprises a plurality of badge entries listed there within wherein, the badge entries comprise badge information pertaining to various virtual badges, the users of which have been pre-granted access into the restricted area. The system is configured such that, badge entries can be added to or removed from the access database 22 in real time. In one embodiment, the access database 22 is not a part of a single virtual card reader 20 but is shared by multiple virtual card readers 20 over a wireless communications network, such as the Internet. The virtual badge reader 20 further comprises an interactive means for receiving badge information from a virtual badge upon the corresponding smart device 16 being brought proximal thereto. More particularly, the badge information is received via a wireless communications network 18, such as Bluetooth, Wi-Fi, Near Field Communication (NFC), infrared, etc. In one embodiment, the interactive means comprises a scanner for scanning the virtual badge.

Still referring to FIG. 2, upon the reception of the badge information from the smart device 16, the comparison module 24 parses the access database 22 and compares the received badge information against the badge entries. Upon match, the lock/unlock module 28, which actually controls the locking mechanism of the point of access, unlocks it thereby allowing the user to enter there through into the restricted area.

Another embodiment of the present invention comprises a computer-implemented electronic surveillance method for permitting a user's entrance into a restricted area based on a virtual badge wherein, the virtual badge is representative of the user. Similar to the earlier embodiment, the virtual badge is resides within the user's smart device such as a smartphone, tablet, or the like.

In one embodiment, the system comprises an online hotel reservation system. The hotel reservation system comprises a customer reservation form comprising a plurality of input fields wherein, the customer reservation form is accessible via a customer interface pertaining to the user's smart device. The hotel reservation system further comprises at least one payment gateway for receiving payment towards booking charges of a hotel room wherein, the point of entry of the hotel room is associated with an access means. Upon the booking charges being paid via the payment gateway, the user details are stored within the user database and a virtual badge is generated, which is accessible by the user via the customer interface. The access means configured to allow the bearer of the virtual badge within the hotel room upon receiving the badge information pertaining to the virtual badge.

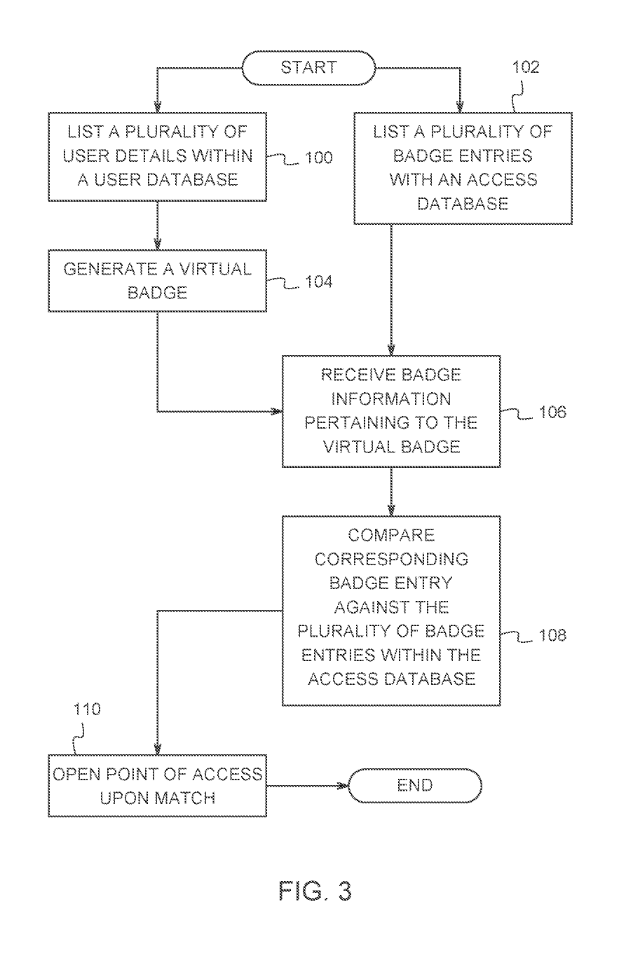

Referring to FIG. 3, the method initiates with a plurality of user details being listed (step 100) within a user database. The user details include the identity details, professional details, and the contact details of the user. The identity details of the user comprise the name, a photo image of the user, etc. The professional details of the user comprise the company which employed the user, the department of the user, the designation of the user, etc. The contact details of the user include the one or more phone numbers of the user, one or more email addresses of the user, one or more postal addresses of the user, etc. The method further includes listing (step 102) a plurality of badge entries within an access database wherein, the badge entries comprise badge information pertaining to various virtual badges, the users of which have been pre-granted access into the restricted area. Notably, badge entries can be added to or removed from the access database in real time.

Still referring to FIG. 3, the method further comprises generating a virtual badge (step 104) based on the user details that are provided. The virtual badge may comprise an image file, a QR code, or even a barcode. Further, the method comprises receiving badge information (step 106) pertaining to the virtual badge upon the corresponding smart device being brought proximal to a virtual badge reader, which controls the point of access of the restricted area. Upon the reception of the badge details, the method further includes comparing (step 108) the received badge information against the badge entries within the access database. The method finally ends with, in the event of a match between the user details and a badge entry, unlocking the point of access (step 110) for the user to enter there through into the restricted area.

In one embodiment, the method initiates with receiving user details within a customer reservation form comprising a plurality of input fields wherein, the customer reservation form is accessible via a customer interface pertaining to the user's smart device. The method further comprises, via at least one payment gateway, receiving payment towards booking charges of a hotel room, the point of entry of which associated with the access means. The method further comprises, upon the booking charges being paid via the payment gateway, storing the user details within the user database and generating a virtual badge, which is accessible by the user via the customer interface. Finally, the method further comprises allowing the bearer of the virtual badge within the hotel room upon the access means receiving the badge information pertaining to the virtual badge.

The aforementioned embodiments are able to be implemented, for example, using a machine-readable medium or article which is able to store an instruction or a set of instructions that, if executed by a machine, cause the machine to perform a method and/or operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A computer-implemented electronic surveillance system for allowing a user's entrance into a restricted area based on a virtual badge, which is representative of the user, the system comprising:
(a) a user database listed with a plurality of user details including the identity details of the user;
(b) a badge generation module for generating a virtual badge based on the user details, the virtual badge residing within a smart device;
(c) an access database comprising a plurality of badge entries listed there within wherein, each badge entry comprising badge information representative of a virtual badge, the user of which has been pre-granted the right to access the restricted area; and
(d) an access means associated with the point of access of the restricted area, the access means comprising:
(i) an interactive means for, upon the smart device being brought proximal to the access means, receiving badge information there from, the received badge information pertaining to the corresponding virtual badge; and
(ii) a comparison module disposed in operative communication with the access database, the comparison module for comparing the received badge information against the virtual badge entries listed within the access database wherein, upon match, the restricted area is rendered accessible to the user.

2. The system of claim 1 wherein, the user details further include the contact details of the user.

3. The system of claim 1 wherein, the user details further include the professional details of the user, which include the company for which the user works, the department of the user, and the designation of the user.

4. The system of claim 1 wherein, the identity details further include an image of the user.

5. The system of claim 1 wherein, the badge information from the smart device is received by the access means via one of Near Field Technology (NFC), Bluetooth, Internet Protocol, Wi-Fi, and infrared.

6. The system of claim 1 wherein, the access means comprises a virtual badge reader for reading the badge as enabled by the interactive means.

7. The system of claim 1 wherein, the interactive means comprises a scanner.

8. The system of claim 1 wherein, the smart device comprises one of a smartphone, a tablet, and a laptop.

9. The system of claim 1 wherein, the user database and the badge generation module are part of a computer application installed within the smart device; the computer application further comprising a user interface for enabling the user to interact therewith.

10. The system of claim 1 wherein, the restricted area comprises a hotel.

11. The system of claim 10 further comprising an online hotel reservation system comprising:
(a) a customer reservation form comprising a plurality of input fields for receiving user details via a customer interface pertaining to the user's smart device; and
(b) at least one payment gateway for receiving payment towards booking charges of a hotel room; the point of entry of the hotel room associated with the access means;
wherein, upon the booking charges being paid via the payment gateway, the user details are stored within the user database and a virtual badge is generated, which is accessible by the user via the customer interface; the access means configured to allow the bearer of the virtual badge within the hotel room upon receiving the badge information pertaining to the virtual badge.

12. The system of claim 1 wherein, the restricted area comprises a rental premises.

13. A computer-implemented electronic surveillance method for allowing a user's entrance into a restricted area based on a virtual badge, which is representative of the user, the method comprising:
(a) listing a plurality of user details within a user database; the plurality of user details including the identity details of the user;
(b) generating a virtual badge based on the user details, the virtual badge residing within a smart device;
(c) listing a plurality of badge entries within an access database, each badge entry representative of a virtual badge, the user of which has been pre-granted access into the restricted area; and
(d) receiving, upon the smart device being brought proximal to an access means, badge information pertaining to the corresponding virtual badge; and
(e) comparing the received badge information against the virtual badge entries listed within the access database; and
(f) rendering the restricted area accessible to the user upon match.

14. The method of claim 13 wherein, the user details further include the contact details of the user.

15. The method of claim 13 wherein, the user details further include the professional details of the user, which include the company for which the user works, the department of the user, and the designation of the user.

16. The method of claim 13 wherein, the identity details further include an image of the user.

17. The method of claim 13 wherein, the badge information from the smart device is received by the access means via one of Near Field Technology (NFC), Bluetooth, Internet Protocol, Wi-Fi, and infrared.

18. The method of claim 13 wherein, the access means comprises a virtual badge reader.

19. The method of claim 13 wherein, the smart device comprises one of a smartphone, a tablet, and a laptop.

20. The method of claim 13 wherein, the restricted area comprises a hotel, airbnb, house, garage, club house, convention centers, sport stadiums etc.

21. The method of claim 20 further comprising:
(a) receiving user details within a customer reservation form comprising a plurality of input fields; the customer reservation form accessible via a customer interface pertaining to the user's smart device;
(b) via at least one payment gateway, receiving payment towards booking charges of a hotel room, the point of entry of which associated with the access means;
(c) storing the user details within user database upon the payment of the booking charges;
(d) generating a virtual badge representative of the user, the virtual badge accessible by the user via the customer interface; and
(e) allowing the bearer of the virtual badge within the hotel room upon the access means receiving the badge information pertaining to the virtual badge.

22. The method of claim 13 wherein, the restricted area comprises a rental premises.

23. A computer-implemented electronic surveillance system for allowing a user's entrance into a restricted area based on a virtual badge, which is representative of the user, the system comprising:
(a) a user database listed with a plurality of user details including the identity details of the user;
(b) a badge generation module for generating a virtual badge based on the user details, the generated virtual badge residing within a smart device;
(c) an access database comprising a plurality of badge entries listed therewithin wherein, each badge entry comprising badge information representative of a virtual badge, the user of which has been pre-granted the right to access the restricted area; and
(d) an access means associated with the point of access of the restricted area, the access means comprising:
(i) an interactive means for, upon the smart device being brought proximal to the access means, receiving badge information therefrom, the received badge information pertaining to the corresponding virtual badge, the badge information received via one of Near Field Technology (NFC), Bluetooth, Internet Protocol, Wi-Fi, and infrared; and
(ii) a comparison module disposed in operative communication with the access database, the comparison module for comparing the received badge information against the virtual badge entries listed within the access database wherein, upon match, the restricted area is rendered accessible to the user.
